(19) United States
(12) Patent Application Publication
(10) Pub. No.: US 2025/0279246 A1
(43) Pub. Date: Sep. 4, 2025

(54) Solid Electrolytic Capacitor with Improved ESR and Leakage

(71) Applicant: KEMET Electronics Corporation, Fort Lauderdale, FL (US)

(72) Inventors: Yaru Shi, Simpsonville, SC (US); Antony Chacko, Simpsonville, SC (US); Ajaykumar Bunha, Simpsonville, SC (US)

(21) Appl. No.: 18/594,540

(22) Filed: Mar. 4, 2024

(51) Int. Cl. H01G 9/028; H01G 9/042; H01G 9/08; H01G 9/15

(52) U.S. Cl. CPC H01G 9/028; H01G 9/042; H01G 9/08; H01G 9/15

(57) ABSTRACT

Provided is an improved method for preparing an electrolytic capacitor comprising:
forming an anode with a dielectric on the anode;
forming a conductive polymer layer on the dielectric wherein the forming of the conductive polymer layer comprises sequential applying multiple layers of a conductive polymer on the dielectric;
applying a treatment to the conductive polymer layer wherein the treatment comprises applying a dopant wherein the dopant comprises:
a carboxylic acid compound defined by the formula:

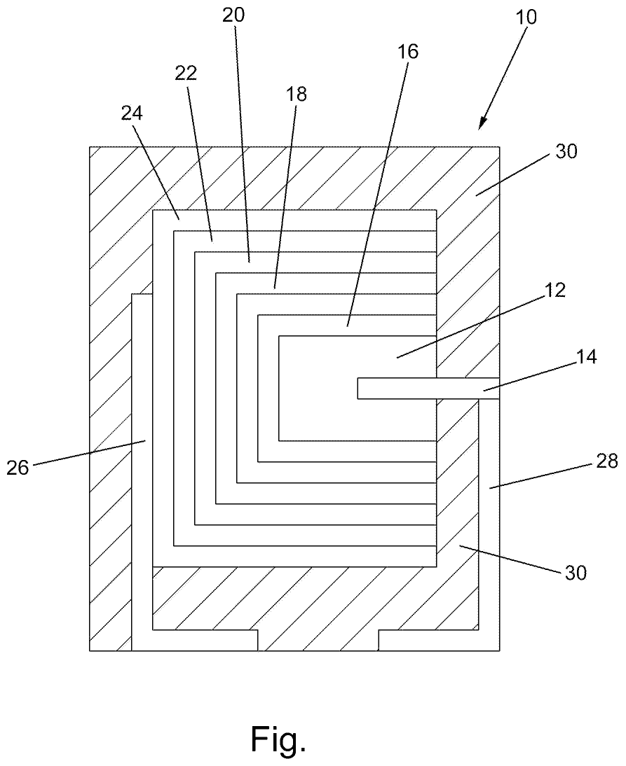

R²—(C(O)OX³)ₘ; and
a compound selected from the group consisting of:
an aromatic sulfonate compound defined by the formula:

R¹—(S(O)₂OX¹)ₙ
and a phosphorus containing compound defined by:

R³—(OₓP(O)(OX⁴)₂)ₚ
wherein all groups are defined.

### FIELD OF THE INVENTION

The present invention is related to an improve solid electrolytic capacitor and, more specifically, a method of forming a solid electrolytic capacitor with improved equivalent series resistance (ESR) and leakage current. More specifically, the present invention is related to a dual function additive applied to the external surface of the conductive polymer layer wherein the dual function additive provides superior doping to the conductive polymer.

### BACKGROUND

Solid electrolytic capacitors utilizing conductive polymeric cathodes are widely used in the art and with great success. There are many advantages to conductive polymer cathodes, particularly relative to manganese dioxide cathodes. Further growth in the use of solid electrolytic capacitors comprising conductive polymers requires further improvements in ESR and leakage.

There have been many approaches focused on improving the properties of conductive polymers and the performance of capacitors formed therewith. One approach has focused on the formation of the polymer itself. An example of this approach is the mixing of an alkylamine salt or imidazole salt of an organic sulfonic acid as a dopant into an oxidation solution used for chemical polymerization in an effort to reduce capacitor ESR and to improve thermal stability. Phenols or naphthol sulfonate dopants have been used with divalent or multivalent cations such as Ca²⁺, Mg²⁺, Al³⁺, ethylene diamine or imidazole cations as a polymerization accelerator to achieve higher ESR stability. A similar approach, specific to pyrroles, has been electrolytic oxidation polymerization in the presence of various aromatic compounds. The aromatic compounds carry electron-withdrawing groups such as sulfo or carboxy, and an electron-donating group such as hydroxy or electrolytic oxidation polymerization of pyrrole in the presence of an aromatic compound having a sulfo group and at least two functional groups selected from carboxy and hydroxy groups. It has been determined that the use of a dopant as part of the polymerization affects the conductive polymer's conductivity due to the specific structure of the dopant. Furthermore, tedious purification steps are necessary after polymerization to remove ionic impurities, which is detrimental to the polymer, and the purification steps are hypothesized to reduce the amount of dopant which negatively impacts ESR.

The addition of cyclic imidazole salts, esters of gallic acid, and aromatic compounds comprising at least one hydroxy group, such as trihydroxy benzene and trihydroxy benzoate, into a conductive polymer slurry have shown improvements in thermal stability. The limitation of this approach is that the conductive polymer composition must be a preformed stable solution or dispersion and compatible with the additives. This approach is not useful for many solid electrolytic capacitors that contain conductive polymer made via “in situ” polymerization instead of preformed polymer solution or dispersion. Furthermore, the polymer layer is typically formed by the application of multiple layers. Additives in the conductive polymer layer often alter the surface of the layer which can be detrimental to the formation of an intimate bond with subsequent layers. Poor bonding between adjacent layers has been hypothesized as being detrimental to ESR and other properties.

Applying, and then sometimes partially removing, a stabilizer on a preformed conductive polymer as a separate layer has been cited to overcome the limitations of conductive polymeric cathodes. Aromatic hydroxy compounds, aromatic sulfonate compounds and aromatic compounds containing hydroxy groups have been described. The sequential treatment of conductive polymer using a hydroxy aromatic compound solution, for example, has been described. These aromatic hydroxy compounds enhance ESR thermal stability because of their well-known antioxidant property. Aromatic sulfonate compounds, on the other hand, improve ESR thermal stability because of their strong doping characteristic. Organic sulfonic acid anion and a non-transition inorganic divalent or multivalent cations have also been described. The multivalent cations often cause the produced organic sulfonates to have poor solubility which is problematic in production and the poor solubility makes it difficult to form coatings having sufficient coverage of the underlying surface.

Aromatic sulfonate compounds are the most common dopants for conductive polymers. However, aromatic sulfonate dissociates very easily in the presence of moisture, and tends to cause leakage problems for capacitors under high humidity. Many other strong acids; such as sulfuric acid, nitric acid, phosphoric acid, and formic acid; have been reported as post treatment for conductive polymer film to improve conductivity specifically when the conductive polymer is poly-(3,4-ethylenedioxythiophene) (PEDOT) with a polystyrene sulfonate (PSS) polyanion. Nonetheless, these treatments had the same problem as aromatic sulfonate compounds and were often followed by washing steps to remove excess free acids to avoid corrosion and other side effects. Strong acids with their very low dissociation constants are preferred as they can dope PEDOT:PSS by forming charge transfer mechanisms. Weak acids, for example carboxylic acids or their salts, have also been explored but did not get as much attention because of their weak doping efficiency.

The application of materials between polymer layers has been reported such as sulfonate with phosphate, phosphonate, carboxyl, or hydroxy groups either in one compound or in different compounds, in the presence of alkylamino cations. The treatment solution was applied between two conductive polymer layers as a crosslinker to reduce ESR and leakage. This approach has some limitations. Each subsequent layer of conductive polymer must be a preformed conductive polymer solution or dispersion. Solubility of the treatment compounds in the second conductive polymer was designed to be relatively low, with longer alkylamine being preferred, otherwise the dried treatment compounds may dissolve into the subsequent conductive polymer solution or dispersion, making it difficult to control quantity of the treatment. In addition, as an intermediate coating, the treatment compounds may not be evenly distributed throughout the subsequent conductive polymer layers. Therefore, the coating quality was difficult to achieve which is detrimental to ESR and other properties.

In spite of the extensive efforts there remains a demand for solid electrolytic capacitors with improved ESR stability and improved leakage, especially high temperature high humidity leakage performance. Provided herein is an improved process for forming a solid electrolytic capacitor and an improved capacitor formed thereby.

### SUMMARY OF THE INVENTION

The present invention is related to an improved solid electrolytic capacitor, particularly, with improved reliability.

A particular feature of the invention is improved stability after storing at high temperature.

A particular advantage is the ability to form multiple layers of conductive polymer sequentially followed by addition of a treatment comprising a dopant after completion of the layered conductive polymer coating without dopant added to or between the sequential layers.

These and other advantages, as will be realized, are provided in a method for preparing an electrolytic capacitor comprising:
forming an anode with a dielectric on the anode;
forming a conductive polymer layer on the dielectric wherein the forming of the conductive polymer layer comprises sequential applying multiple layers of a conductive polymer on the dielectric;
applying a treatment to the conductive polymer layer wherein the treatment comprises a dopant wherein the dopant comprises:
a carboxylic acid compound defined by the formula:

R²—(C(O)OX³)ₘ
wherein:
R² is an aliphatic chain, an aliphatic ring or an aromatic ring and wherein R² is substituted with at least one group selected from the group consisting of —C(O)OX², —OH and an amine; and if R² is an aliphatic chain or an aliphatic ring m is 1 and if R² is an aromatic ring m is at least 1;
X³ is a monovalent cation selected from the group consisting of H⁺, Li⁺, Na⁺, NH₄⁺ and
an organic amino cation; and
an aromatic sulfonate compound defined by the formula:

R¹—(S(O)₂OX¹)ₙ
wherein R¹ is an aromatic ring optionally substituted with at least one group selected from the group consisting of —(S(O)₂OX², —C(O)OX², —OH and an amine;
X¹ and X² are independently a monovalent cation selected from the group consisting of
H⁺, Li⁺, Na⁺, NH₄⁺ and organic amino cation; and n is an integer of at least 1.

Yet another embodiment is provided in a method for preparing an electrolytic capacitor comprising:
forming an anode with a dielectric on the anode;
forming a conductive polymer layer on the dielectric wherein the forming of the conductive polymer layer comprises sequential applying multiple layers of a conductive polymer on the dielectric;
applying a treatment to the conductive polymer layer wherein the treatment comprises applying a dopant wherein the dopant comprises:
a carboxylic acid compound defined by the formula:

R²—(C(O)OX³)ₘ
wherein:
R² is an aliphatic chain, an aliphatic ring or an aromatic ring and wherein R² is substituted with at least one group selected from the group consisting of —C(O)OX², —OH and an amine; and if R² is an aliphatic chain or an aliphatic ring m is 1 and if R² is an aromatic ring m is at least 1;
X³ is a monovalent cation selected from the group consisting of H⁺, Li⁺, Na⁺, NH₄⁺ and an organic amino cation; and
a compound selected from the group consisting of:
an aromatic sulfonate compound defined by the formula:
R¹—(S(O)₂OX¹)ₙ
wherein R¹ is an aromatic ring optionally substituted with at least one group selected from the group consisting of —(S(O)₂OX², —C(O)OX², —OH and an amine;
X¹ and X² are independently a monovalent cation selected from the group consisting of H⁺, Li⁺, Na⁺, NH₄⁺ and organic amino cation; and
n is an integer of at least 1;
and a phosphorus containing compound defined by:

R³—(OₓP(O)(OX⁴)₂)ₚ
wherein R³ is —OH, an optionally substituted aliphatic chain of up to 10 carbons, an optionally substituted aliphatic ring of up to 10 carbons or an optionally substituted aromatic ring;
each X⁴ is independently selected from H⁺, Li⁺, Na⁺, NH₄⁺ and organic amino cation;
x is 0 or 1 with the proviso that when x=1, R³ is not —OH; and
p is an integer indicating the number of groups on R³ and preferably at least 2 to no more than 6.

Yet another embodiment is provided in a method for preparing an electrolytic capacitor comprising:
forming an anode with a dielectric on the anode;
forming a conductive polymer layer on the dielectric wherein the forming of the conductive polymer layer comprises sequential applying multiple layers of a conductive polymer on the dielectric;
applying a treatment to the conductive polymer layer wherein the treatment comprises a dopant wherein the dopant comprises a phosphorus containing compound defined by:

R³—(OₓP(O)(OX⁴)₂)ₚ
wherein R³ is —OH, an optionally substituted aliphatic chain of up to 10 carbons, an optionally substituted aliphatic ring of up to 10 carbons or an optionally substituted aromatic ring;
each X⁴ is independently selected from H⁺, Li⁺, Na⁺, NH₄⁺ and organic amino cation;
x is 0 or 1 with the proviso that when x=1, R³ is not —OH; and
p is an integer indicating the number of groups on R³ and preferably at least 2 to no more than 6.

### BRIEF DESCRIPTION OF DRAWINGS

FIGURE is a cross-sectional schematic view of an embodiment of the invention.

### DESCRIPTION

The present invention is related to an improved process for forming a solid electrolytic capacitor and an improved capacitor formed thereby. The application of a dual function coating layer after the last conductive polymer is formed, preferably without subsequent removal of the coating layer, improves ESR thermal stability and high temperature high humidity leakage.

The dual function coating layer comprises a dual function composition selected from the group consisting of an aromatic sulfonate compound and a carboxylic acid compound; phosphorous containing compounds comprising one or more phosphonate group; and a phosphate or phosphonate compound combined with a carboxylic acid compound. This combination treatment has synergic effect on ESR thermal stability, better than either component by itself. The ESR benefit is unexpected, considering carboxylic acid compounds' weak doping efficiency. The better high humidity leakage is also surprising because the strong dissociating sulfonate groups were never removed or covered by a conductive polymer layer or other electrolyte materials.

While not limited to theory, it is hypothesized that by applying the dual function coating after the last conductive polymer layer is formed, made either via in-situ polymerization or preformed conductive polymer solution or dispersion, provides a more uniform distribution of the treatment compounds throughout the conductive polymer. This process also allows direct interaction of the dual function composition with subsequent cathode components, such as carbon paste, that is often applied after the last conductive polymer layer is formed. The aromatic sulfonate compound, phosphate or phosphonate compound and carboxylic acid compound in the dual function composition preferably comprise monovalent cations selected from H⁺, Li⁺, Na⁺, NH₄⁺ and organic amino cations with non H⁺ cations; or more preferably Li⁺, Na⁺, NH₄⁺ and organic amino cations; accounting for at least 15 molar % of the total cations.

The dual function composition is applied after the last conductive polymer layer is applied and can be applied as a premixed solution or, when the functionality is provided by a mixture of components, the components can be added separately and either sequentially or simultaneously. The dual function composition is effective and mitigates the deficiencies created by the sequential formation of sub-layers of the cathode especially when combinations of methods are used such as formation by in-situ polymerizing of a monomer on the dielectric followed by deposition of a preformed conductive polymer solution or dispersion with either small molecule anions, polymeric counter anions or self-doping functionalities.

The aromatic sulfonate compound has the chemical formula:

R¹—(S(O)₂OX¹)ₙ
wherein R¹ is an aromatic ring substituted with at least one group selected from the group consisting of —(S(O)₂OX², —C(O)OX², —OH and an amine and most preferably at least two groups, and preferably no more than 5 groups, selected from the group consisting of —(S(O)₂OX², —C(O)OX², and —OH;
X¹ and X² are independently a monovalent cation selected from the group consisting of
H⁺, Li⁺, Na⁺, NH₄⁺ and organic amino cation;
n is an integer of at least 1 and preferably at least 2 to no more than 6.

The carboxylic acid compound has the chemical formula:

R²—(C(O)OX³)ₘ
wherein:
R² is an aliphatic chain, an aliphatic ring or an aromatic ring and wherein R² is optionally substituted with at least one group selected from the group consisting of —OH and an amine;
X³ is a monovalent cation selected from the group consisting of H⁺, Li⁺, Na⁺, NH₄⁺ and an organic amino cation; wherein
if R² is an aliphatic chain or an aliphatic ring m is 1 and if R² is an aromatic ring m is at least 1, preferably at least 2 and preferably no more than 6. R² may be a small molecule with less than 10 carbons or a polymeric acid.

The phosphorus containing compound has the chemical formula:

R³—(OₓP(O)(OX⁴)₂)ₚ
wherein R³ is —OH, an optionally substituted aliphatic chain of up to 10 carbons, an optionally substituted aliphatic ring of up to 10 carbons or an optionally substituted aromatic ring;
each X⁴ is independently selected from H⁺, Li⁺, Na⁺, NH₄⁺ and organic amino cation;
x is 0 or 1 with the proviso that when x=1, R³ is not —OH; and
p is an integer indicating the number of groups on R³ and preferably at least 2 to no more than 6.

Exemplary phosphorus containing compounds include ammonium, lithium, sodium mono or dihydrogen phosphate, monovalent salt of phytic acid, methyl phosphonic acid, ethyl phosphonic acid, 1,4-phenylene bis(phosphonic acid, methyl or dimethyl phosphate, dimetylphosphate, ethyl or diethyl phosphate, phenyl phosphate, diphenyl phosphate or hexafluorophosphate. Compounds containing two or more phosphonate groups, wherein p is at least 2, in one molecule are particularly preferred and particularly monovalent salt of phytic acid, polyvinylphosphonic acid, ethylenediamine tetramethylene phosphonic acid, or other oligomers or polymers containing more than one phosphonate functionality.

The ratio of carboxylate groups to sulfonate groups is important to achieve the desirable properties. An excess of carboxylate groups may reduce ESR thermal stability benefit while an excess of sulfonate groups may affect humidity leakage benefit. The molar ratio of carboxylate groups from the carboxylic acid compound to the combined carboxylate and sulfonate groups from both the carboxylic acid compound and aromatic sulfonate compound is preferably between 10% to 90%. By way of non-limiting example, with a dicarboxylic acid as the carboxylic acid and an aromatic sulfonate compound comprising one sulfonate group and one carboxylic acid group the molar ratio is preferably no less than 1 to 10; which equates to 12 moles of carboxylate groups, from the dicarboxylic acid and the aromatic sulfonate compound, and 22 moles of carboxylate and sulfonate combined from the dicarboxylic acid and the aromatic sulfonate compound (% Carbox is 12/22=55%); to 4 to 1 which equates to 9 moles of carboxylic groups, from the dicarboxylic acid and the aromatic sulfonate compound, to 10 moles of carboxylate and sulfonate combined from the dicarboxylic acid and the aromatic sulfonate compound (% Carbox is 9/10=90%). Another non-limiting example, with a dicarboxylic acid as the carboxylic acid and an aromatic sulfonate compound comprising two sulfonate groups the molar ratio is preferably no less than 1 to 8; which equates to 2 moles of carboxylate groups, from the dicarboxylic acid, and 18 moles of carboxylate and sulfonate combined from the dicarboxylic acid and the aromatic sulfonate compound (% Carbox is 2/18=11%); to 4 to 1 which equates to 8 moles of carboxylic groups, from the carboxylic acid compound, to 10 moles of carboxylate and sulfonate combined from the dicarboxylic acid and the aromatic sulfonate compound (% Carbox is 8/10=80%). Similarly, the molar ratio of carboxylate groups from carboxylic acid, to the phosphate group or phosphonate is preferably between 10% to 90%.

The solvent used for “Dual Function” treatment preferably has affinity to conductive polymer but does not dissolve it.

Antioxidant compounds can be applied before, after or together with the dopant treatment to achieve a synergic benefit. The antioxidant can be a hydroxy containing aromatic compound; phosphorus containing antioxidants, such as phosphite, or sulfur containing antioxidant such as sulfites and the like.

“Dual Function” treatment is preferably applied after the last conductive polymer layer is formed to improve both ESR thermal stability and high temperature high humidity leakage. The “Dual Function” treatment can be a combination of an aromatic sulfonate compound and a carboxylic acid compound; a combination of a phosphate or phosphonate compound and a carboxylic acid compound; or a phosphorous containing compound comprising one or more phosphonate groups. This “Dual Function” treatment provides synergic effects on ESR thermal stability. This “Dual Function” treatment also improves high temperature, high humidity leakage even though the treatment is not removed or covered by a subsequently formed conductive polymer layer.

The invention will be described with reference to the FIGURES which are an integral, but non-limiting, part of the specification provided for clarity of the invention.

An embodiment of the invention will be described with reference to the FIGURE. In FIGURE, an inventive capacitor, 10, is illustrated schematically in cross-sectional view. The capacitor comprises an anode, 12, which is preferable a porous monolith formed by pressing a powder. An anode wire, 14, extends from the anode. The anode wire can be embedded in the powder prior to pressing, which is preferred, or the anode wire can be attached to the surface of the anode after pressing such as by welding. A dielectric, 16, is formed on the surface of the anode. While illustrated as a layer of consistent thickness the actual dielectric layer is on the interstitial surfaces of the porous monolith. An optional, but preferred internal layer, 17, is on the dielectric wherein the internal layer is preferably an in-situ formed layer. Sequential electrolyte layers, 18 and 20, are formed on the internal layer, or dielectric, and preferably extends into the interstitial surfaces of the monolith to increase the surface area of conductive polymer coating. The number of sequential electrolyte layers may be large with each sequential electrolyte layer preferably being formed by an application of dispersion of slurry. A first adhesion layer, 22, preferably comprising carbon, is optionally but preferably formed on the solid electrolyte layer. A second adhesion layer, 24, preferably comprising a solderable metal, is optionally but preferably formed on the first adhesion layer. The adhesion layers allow electrical attachment of a cathode lead, 26, to the solid electrolyte layers such as by soldering or by a conductive adhesive as known in the art. It is known in the art that attachment of a lead to a conductive polymer layer is difficult and an adhesion layer is typically used to allow good physical and electrical contact between the conductive polymer layer and cathode lead. An anode lead, 28, is in electrical contact with the anode wire. An optional but preferred electrically protective coating, 30, encases all but the bottom portion of the cathode lead and anode lead.

A particularly preferred anode material is a metal and a particularly preferred metal is a valve metal or a conductive oxide of a valve metal. Particularly preferred anodes comprise a material selected from the group consisting of niobium, aluminum, tantalum and NbO. Tantalum is the most preferred anode material. Preferred are high charge density powders such as above 50,000 CV/g. Particularly preferred powders have a charge density above 100,000 CV/g, preferably above 200,000 CV/g and even more preferably above about 250,000 CV/g up to about 350,000 CV/g.

The anode wire is either embedded in or attached to the anode with a preference for an embedded anode wire. The material of construction for the anode wire is not particularly limited, however, it is preferable that the anode wire be the same material as the anode for manufacturing conveniences.

The dielectric, and method of forming the dielectric, is not particularly limited herein. A particularly preferred dielectric is an oxide of the anode due to manufacturing considerations.

The conductive polymer layer is formed by sequential formation of multiple sub-layers via in-situ polymerization, deposition of conductive polymer solution or dispersion, with either small molecule anions, polymeric counter anions or self-doping functionalities. The conductive polymer can also be formed by combinations of these methods. The ‘Dual Function” treatment theoretically is more advantageous when applied onto in-situ polymer, because small molecule dopants that is often used for in-situ polymers de-dope more easily. Small molecule dopants are monomeric compounds that contain an anionic functionality. A particularly advantageous small molecule dopant is p-toluene sulfonic acid.

A soluble conductive polymer is believed to impregnate the pores of anodes as effectively as conductive polymers formed by in-situ methods and better than conductive polymer dispersion with detectable particles. In many cases, soluble conductive polymers contain self-doping functionalities. Similar to in-situ conductive polymer, soluble conductive polymer does not contain polyanion dopants such as polystyrene sulfonic acid. The “Dual Function” treatment theoretically could also provide similar ESR thermal stability benefit when applied on to self-doped conductive polymer layer.

The present invention is particularly advantageous when used in combination with conductive polymers comprising small molecule dopants or self-doping functionalities.

The conductive polymer layer may comprise a crosslinker to improve inter-layer adhesion. Crosslinkers are well known in the art as exemplified in U.S. Pat. Nos. 8,882,856; 9,761,347; 9,761,378; 10,109,428 and 10,643,796 which are incorporated herein by reference. Cross-linking comprises the use of a material comprising at least two cross-linkable functionalities wherein one cross-linkable functionality forms a first bond and the second cross-linkable functionality forms a second bond thereby forming a bridge of cross-linking molecule between two molecules, oligomers, polymer or portions of a polymer. For the purposes of this disclosure the term “crosslinked” is defined as the reaction product of a crosslinker since the crosslinker is not present as a separate compound after crosslinking. The cross-linkable functionality may form a covalent bond or an ionic bond.

The crosslinking may be between functional groups of the conductive polymer or a molecule, oligomer, or polymer. Crosslinkable functionality can be added to the conductive polymer layers thereby improving the layer integrity and the surface coverage or a crosslinkable material may be added to the conductive polymer layer. Once exposed to curing conditions, which is typically thermal curing, the crosslinkable molecules react with the crosslinker thereby forming a strongly bound interpenetrating network of covalent and ionic bonds. The crosslinkable materials preferably comprise two components with one component preferably being a compound, oligomer or polymer with multifunctional or multiple reactive groups which are well known in the art. The reactive groups are preferably selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides. The oligomer or polymer with multifunctional or multiple reactive groups preferably includes at least one carboxylic acid group and at least one hydroxyl function group. A particularly preferred oligomer or polymer with multifunctional reactive groups is a polyester containing carboxylic and hydroxyl functionality. In addition to oligomers or polymers, particles with surface functional groups can also take part in the crosslinking.

Crosslinkers includes silane compounds, epoxy compounds and other di- or multi-functional compounds. Particularly preferred crosslinkers comprise melamines, isocyanates, epoxies, hexamethoxymelamines, glyoxals, furfural aldehydes, melamine formaldehyde condensates, divinyl sulfones and epoxy compounds.

Organofunctional silanes and organic compounds with more than one crosslinking group, especially more than one epoxy group, are particularly suitable for use as crosslinkers for the instant invention especially when used in combination.

An exemplary organofunctional silane is defined by the formula:

XR₁Si(R₃)₃₋ₙ(R₂)ₙ

wherein X is an organic functional group such as amino, epoxy, anhydride, hydroxy, mercapto, sulfonate, carboxylate, phosphonate, halogen, vinyl, methacryloxy, ester, alkyl, etc; R₁ is an aryl or alkyl (CH₂)ₘ wherein m can be 0 to 14; R₂ is individually a hydrolysable functional group such as alkoxy, acyloxy, halogen, amine or their hydrolyzed product; R₃ is individually an alkyl functional group of 1-6 carbons; n is 1 to 3.

The organofunctional silane can also be dipodal, define by the formula:

Y(Si(R₃)₃₋ₙ(R₂)ₙ)₂

wherein Y is any organic moiety that contains reactive or nonreactive functional groups, such as alkyl, aryl, sulfide or melamine; R₃, R₂ and n are defined above. The organofunctional silane can also be multi-functional or polymeric silanes, such as silane modified polybutadiene, or silane modified polyamine, etc.

Particularly preferred organofunctional silanes are selected from the group consisting of: 3-glycidoxypropyltrimethoxysilane, 3-aminopropytriethoxysilane, aminopropylsilanetriol, (triethoxysilyl)propylsuccinic anhydride, 3-mercaptopropyltrimethoxysilane, vinyltrimethoxysilane, 3-methacryloxypropyltrimethoxysilane, 3-trihydroxysilyl-1-propane sulfonic acid, octyltriethyoxysilane, bis(triethoxysilyl)octane, etc. The examples are used to illustrate the invention and should not be regarded as conclusive.

A particularly preferred organofunctional silane is glycidyl silane defined by the formula:

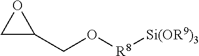

wherein R⁸ is an alkyl of 1 to 14 carbons and more preferably selected from methyl ethyl and propyl; and each R⁹ is independently an alkyl or substituted alkyl of 1 to 6 carbons.

A particularly preferred glycidyl silane is 3-glycidoxypropyltrimethoxysilane defined by the formula:

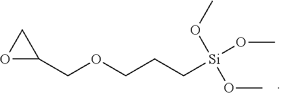

A crosslinker with at least two epoxy groups is referred to herein as an epoxy crosslinking compound and is defined by the formula:

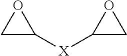

wherein the X is an alkyl or substituted alkyl of 0-14 carbons, preferably 0-6 carbons; an aryl or substituted aryl, an ethylene ether or substituted ethylene ether, polyethylene ether or substituted polyethylene ether with 2-20 ethylene ether groups or combinations thereof. A particularly preferred substitute is an epoxy group.

Particularly preferred epoxy crosslinking compounds having more than one epoxy groups are selected from the group consisting of: ethylene glycol diglycidyl ether (EGDGE), propylene glycol diglycidyl ether (PGDGE), 1,4-butanediol diglycidyl ether (BDDGE), pentylene glycol diglycidyl ether, hexylene glycol diglycidyl ether, cyclohexane dimethanol diglycidyl ether, resorcinol glycidyl ether, glycerol diglycidyl ether (GDGE), glycerol polyglycidyl ethers, diglycerol polyglycidyl ethers, trimethylolpropane polyglycidyl ethers, sorbitol diglycidyl ether (Sorbitol-DGE), sorbitol polyglycidyl ethers, polyethylene glycol diglycidyl ether (PEGDGE), polypropylene glycol diglycidyl ether, polytetramethylene glycol diglycidyl ether, di(2,3-epoxypropyl)ether, 1,3-butadiene diepoxide, 1,5-hexadiene diepoxide, 1,2,7,8-diepoxyoctane, 1,2,5,6-diepoxycyclooctane, 4-vinyl cyclohexene diepoxide, bisphenol A diglycidyl ether, maleimide-epoxy compounds, etc.

A preferred epoxy crosslinking compound is glycidyl ether, defined by the formula:

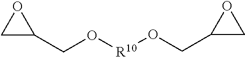

wherein R¹⁰ is an alkyl or substituted alkyl of 1-14 carbons, preferably 2-6 carbons; an ethylene ether or polyethylene ether with 2-20 ethylene ether groups; an alkyl substituted with a group selected from hydroxy, or

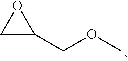

or —(CH₂OH)ₓCH₂OH wherein X is 1 to 14.

Particularly preferred glycidyl ethers are represented by:

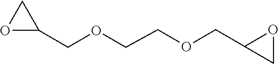 [SMILES: C(COCC1CO1)OCC1CO1]

EGDGE: ethylene glycol diglycidyl ether

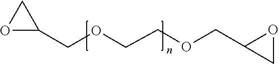

where n is an integer of 1 to 220;
PEGDGE: polyethylene glycol diglycidyl ether

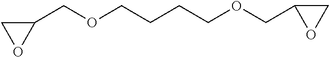 [SMILES: C(CCOCC1CO1)COCC1CO1]

BDDGE: 1,4-butanediol diglycidyl ether

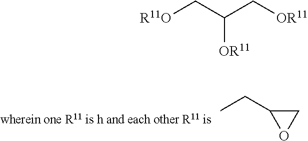

GDGE: glycerol diglycidyl ether

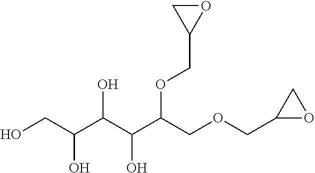 [SMILES: OCC(O)C(O)C(O)C(COCC1CO1)OCC1CO1]

Sorbitol-DGE: sorbitol diglycidyl ether.

Mixtures of the crosslinkers may be used.

A solid electrolytic capacitor typically includes a conductive polymer as part of the cathode. During their applications, solid electrolytic capacitors are often subjected to high temperature and high temperature-high humidity environment. These harsh conditions often cause changes to conductive polymer, which lead to capacitor performance deterioration (capacitance, ESR, leakage, etc). For example, at high temperature, conductive polymer suffers from conductivity loss due to oxidation degradation, and this is often manifested as capacitor ESR increase. Under high temperature and high humidity, for example 85° C./85% RH Humidity, due to ionic species migration in conductive polymer, capacitor may experience sharp leakage increase and possible ESR degradation as well.

Common conductive polymers include cationically charged pyrrole, thiophene, aniline polymers, accompanied by anionic dopants (either monomeric or polymeric).

The preferred polythiophene is shown as polymerized in Formula A:

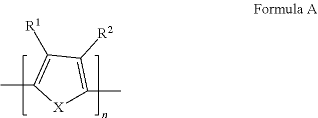

wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements. R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n represents that the compound of Formula A is a polymer with a range of molecular weights; in general n is an integer of 2 to a number sufficient to reach an average molecular weight of about 500,000.

R¹ and R² of Formula A are preferably chosen to prohibit polymerization at the β-site of the ring as it is most preferred that only α-site polymerization be allowed to proceed. It is more preferred that R¹ and R² are not hydrogen and more preferably, R¹ and R² are α-directors with ether linkages being preferable over alkyl linkages. It is most preferred that the R¹ and R² are small to avoid steric interferences.

In a particularly preferred embodiment R¹ and R² of Formula A are taken together to represent —O—(CHR⁴)ₘ—O— wherein m is an integer from 1 to 5 and most preferably 2; each R⁴ is independently selected from hydrogen, a linear or branched C₁ to C₁₈ alkyl radical C₅ to C₁₂ cycloalkyl radical, C₆ to C₁₄ aryl radical C₇ to C₁₈ aralkyl radical or C₁ to C₄ hydroxyalkyl radical, optionally substituted with a functional group capable of providing self-doping functionality and particularly those selected from carboxylic acid, hydroxyl, amine, substituted amines, alkene, acrylate, thiol, alkyne, azide, sulfate, sulfonate, sulfonic acid, imide, amide, epoxy, anhydride, silane, and phosphate; hydroxyl radical; or R⁴ is selected from —(CHR⁵)ₐ—R¹⁶; —O(CHR⁵)ₐR¹⁶; —CH₂O(CHR⁵)ₐR¹⁶; —CH₂O(CH₂CHR⁵O)ₐR¹⁶, or
R⁴ is a functional group selected from the group consisting of hydroxyl, carboxyl, amine, epoxy, amide, imide, anhydride, hydroxymethyl, alkene, thiol, alkyne, azide, sulfonic acid, benzene sulfonic acid sulfate, SO₃M, anhydride, silane, acrylate and phosphate; R⁵ is H or alkyl chain of 1 to 5 carbons optionally substituted with functional groups selected from carboxylic acid, hydroxyl, amine, alkene, thiol, alkyne, azide, epoxy, acrylate and anhydride. R¹⁶ is H, —SO₃M or an alkyl chain of 1 to 5 carbons optionally substituted with functional groups selected from carboxylic acid, hydroxyl, amine, substituted amines, alkene, thiol, alkyne, azide, amide, imide, sulfate, SO₃M, amide, epoxy, anhydride, silane, acrylate and phosphate. a is integer from 0 to 10. M is a H or cation preferably selected from ammonia, sodium or potassium.

A particularly preferred polymer is 3,4-polyethylene dioxythiophene (PEDOT) which is prepared from monomeric 3,4-ethylene dioxythiophene (EDOT).

Particularly preferred conductive polymers include poly(3,4-ethylenedioxythiophene), poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-propane-sulphonic acid, salt), poly(4-(2,3-dihydrothieno-[3,4-b][1,4]dioxin-2-yl)methoxy)-1-methyl-1-propane-sulphonic acid, salt), poly(4-(2,3-dihydrothieno-[3,4-b][1,4]dioxin-2-yl)methoxy alcohol, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-aniline sulfonate), poly(3-aniline sulfonate), and the like.

Particularly suitable polymers or co-polymers are selected from the group consisting of poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-methyl-1-propane-sulphonic acid, salt), poly(N-methylpyrrole), poly(3-methylthiophene), poly(3-methoxythiophene), and poly(3,4-ethylenedioxythiophene). Preferred polyanions are described in U.S. Pat. No. 10,340,091 with polystyrene sulfonate being particularly preferred.

To further improving the capacitor's ESR and leakage performance, a protective coating can be applied after forming the cathode layer. It is preferable to apply the protective coating after application of the carbon layer and more preferably after application of a metal layer such as silver or other terminal metals. The protective coating blocks moisture or oxygen from entering into body of the capacitor and mitigates degradation of cathode conductive polymer. The protective coating material can be any common coating materials including parylene, fluorinated polymer, silicone polymer, polyolefin, polyisobutene, butyl rubber, silicone rubber, polyacrylate, polyurethane, polyvinyl alcohol, polyvinyl acetate, ethylene-vinyl acetate, or derivatives, copolymers and blends of these polymers. Particularly preferred are conformal coating polymeric materials that are suitable for electronic industry.

### EXAMPLES

### Example 1

A series of dopants were formed as follows: Dopant 1 comprised the active component 1,3,(6,7)-naphthalenetrisulfonic acid trisodium; Dopant 2 comprised the active component 1-naphthol-3,6-disulfonic acid disodium salt; Dopant 3 comprised the active component 5-hydroxyisophthalic acid; Dopant 4 comprised the active component 1,2,4,5-benzenetetracarboxylic acid and Dopant 5 comprised the active component 3,4-dihydroybenzoic acid.

A series of capacitors were formed from a similarly prepared anode comprising an oxide as the dielectric. The anode was pressed from a Tantalum powder with charge density of 50,000 CV/g. In each case a cathode layer was forming a first layer by in-situ polymerization of 3,4-ethylenedioxythiophene in the presence of Iron (Ill) p-toluenesulfonate oxidizer, washed and dried. This process was repeated 10 times. After the layer formation was complete an excess of dopant was applied with 4.5 wt % active component in a solvent (water or water-alcohol) and the dopant was allowed to permeate the layers of conductive polymer and followed by drying in a heated oven to remove the solvent. A carbon layer and a silver layer were applied after this step to form the complete cathode layer. A protective coating is applied over the silver layer and the capacitor was encapsulated in a molding epoxy case. The dopants, and relevant ratios if appropriate, are provide in Table 1. Also provided in Table 1 is the molar percent of carboxylate groups from carboxylic acid, to the combined carboxylate and sulfonate groups from the carboxylic acid and the aromatic sulfonate (% Carbox) and the molar percentage of non H⁺ cation out of the total non H⁺ cation and other cations (% Cation).

Each sample was tested for ESR shift after 150° C. storage for 369 hours reported as ESR Shift % in Table 1. ESR Shift %=(Post storage ESR-Initial ESR)/Initial ESR. Leakage was measured using a standard Biased High Accelerated Stress Test (BHAST) and reported as Fliers which are the percentage of samples with a leakage above 0.1 CV %.

Table 1 showed that strong doping stabilizers such as aromatic sulfonate sodium salts are beneficial to 150° C. ESR stability, but BHAST 63h leakage still showed 10% fliers. Carboxylic acid compounds are beneficial to BHAST 63h leakage, but showed large 150° C. ESR shift since they are not good doping stabilizers. Surprisingly, combining aromatic sulfonate salt with carboxylic acid compounds improved both 150° C. ESR stability and BHAST leakage even though the treatment was applied after the last conductive polymer layer.

TABLE 1

| | | | | | | BHAST |
|---|---|---|---|---|---|---|
| | | | | | 369 h ESR | Leakage |
| Sample | Examples | Treatment | % Carbox | % Cation | Shift % | Fliers |
| 1 | Comp. | None | NA | NA | 3196% | 5% |
| | Example | | | | | |
| 2 | Comp. | Dopant 1 | 0% | 100% | 264% | 10% |
| | Example | | | | | |
| 3 | Comp. | Dopant 2 | 0% | 100% | 193% | 10% |
| | Example | | | | | |
| 4 | Comp. | Dopant 3 | 100% | 0% | 714% | 0% |
| | Example | | | | | |
| 5 | Comp. | Dopant 4 | 100% | 0% | 3592% | 0% |
| | Example | | | | | |
| 6 | Comp. | Dopant 5 | 100% | 0% | 2444% | 0% |
| | Example | | | | | |
| 7 | Inv. | Dopant 1 + 3 (1:1) | 61% | 39% | 181% | 10% |
| | Example | | | | | |
| 8 | Inv. | Dopant 1 + 4 (1:1) | 69% | 21% | 235% | 0% |
| | Example | | | | | |
| 9 | Inv. | Dopant 1 + 5 (1:1) | 48% | 52% | 147% | 0% |
| | Example | | | | | |
| 10 | Inv. | Dopant 2 + 3 (1:1) | 66% | 34% | 150% | 0% |
| | Example | | | | | |
| 11 | Inv. | Dopant 2 + 4 (1:1) | 73% | 27% | 193% | 0% |
| | Example | | | | | |

### Example 2

Samples were prepared as in Example 1 except for the dopants. Dopant 6 comprised the active component phosphoric acid; Dopant 7 comprised the active component ammonium dihydrogen phosphate; Dopant 8 comprised the active component sodium dihydrogen phosphate; Dopant 9 comprised the active component phytic acid and Dopant 10 comprised the active component phytic acid ammonium salt. All dopants were applied with 3-4 wt % active component in water with phosphate molar concentration remains the same. ESR shift % was calculated after 150° C. storage for 144 hours. All inventive examples showed improved 150° C. storage life ESR stability with Inventive Sample 17 being the best. It is hypothesized that multiple phosphonate groups in this composition may have different dissociation constants, and resemble the strong dopant-weak dopant combination as shown in Table 1. The superior performance of Sample 17 may also be explained by stronger complexation of the bifunctional dopant to positively charged PEDOT and lower mobility of a bulkier, bifunctional anion vs. a monofunctional phosphate or phosphonate dopant. Phosphate or phosphonate dopant can also be combined with carboxylate dopants or, both sulfonate and carboxylate dopants to achieve optimum ESR and leakage.

| | | | 144 h ESR |
|---|---|---|---|
| Sample | Examples | Treatment | Shift % |
| 12 | Comp. | None | 505.0% |
| | Example | | |
| 13 | Inv. Example | Dopant 6 | 96.3% |
| 14 | Inv. Example | Dopant 7 | 47.3% |
| 15 | Inv. Example | Dopant 8 | 79.9% |
| 16 | Inv. Example | Dopant 9 | 35.7% |
| 17 | Inv. Example | Dopant 10 | 14.8% |

The following references are incorporated by reference: U.S. Pat. Nos. 7,666,326; 7,842,196; 7,651,637; 7,651,639; 8,262,941; 9,362,055; 9,668,868; 10,354,806; 10,340,090; 8,936,735; 10,109,427; 10,109,428 and 11,482,382. U.S. Publ. Appl. Nos. 2006/0223976; 2022/0262569; 2022/0293349; 2018/0068802; 2015/0262754 and 2023/0178306. WO2023/127251A1; WO2023/127826A1; WO2021/230111A1 and JP5988824B2. “Single-step treatment to improve conductivity of PEDOT:PSS by hydrobromic acid solution for application of transparent electrode”. Organic Electronics, 110 (2022), 106643 is incorporated herein by reference.

The invention has been described with reference to preferred embodiments without limit thereto. One of skill in the art would realize additional embodiments which are described and set forth in the claims appended hereto

1. A method for preparing an electrolytic capacitor comprising:
forming an anode with a dielectric on said anode;
forming a conductive polymer layer on said dielectric wherein said forming of said conductive polymer layer comprises sequential applying multiple layers of a conductive polymer on said dielectric;
applying a treatment to said conductive polymer layer wherein said treatment comprises a dopant wherein said dopant comprises:
a carboxylic acid compound defined by the formula:
R²—(C(O)OX³)ₘ
wherein:
R² is an aliphatic chain, an aliphatic ring or an aromatic ring and wherein R² is substituted with at least one group selected from the group consisting of —C(O)OX², —OH and an amine; and if R² is an aliphatic chain or an aliphatic ring m is 1 and if R² is an aromatic ring m is at least 1;
X³ is a monovalent cation selected from the group consisting of H⁺, Li⁺, Na⁺, NH₄⁺ and an organic amino cation;
and
an aromatic sulfonate compound defined by the formula:
R¹—(S(O)₂OX¹)ₙ
wherein R¹ is an aromatic ring optionally substituted with at least one group selected from the group consisting of —(S(O)₂OX², —C(O)OX², —OH and an amine;
X¹ and X² are independently a monovalent cation selected from the group consisting of H⁺, Li⁺, Na⁺, NH₄⁺ and organic amino cation; and
n is an integer of at least 1.

2. The method for preparing an electrolytic capacitor of claim 1 wherein said dopant is not added during said sequential applying multiple layers.

3. The method for preparing an electrolytic capacitor of claim 1 wherein said m is at least 2.

4. The method for preparing an electrolytic capacitor of claim 1 wherein said m is no more than 6.

5. The method for preparing an electrolytic capacitor of claim 1 wherein said R² is substituted with —C(O)OX².

6. The method for preparing an electrolytic capacitor of claim 1 wherein said R² has less than 10 carbons or is a polymeric acid.

7. The method for preparing an electrolytic capacitor of claim 1 wherein Li⁺, Na⁺, NH₄⁺ and organic amino cations accounting for at least 15 molar % of the total cations represented by X¹, X² and X³.

8. The method for preparing an electrolytic capacitor of claim 1 wherein said R¹ is substituted with at least one said —(S(O)₂OX², —C(O)OX² or —OH groups.

9. The method for preparing an electrolytic capacitor of claim 1 wherein said R¹ is substituted with at least two said —(S(O)₂OX², —C(O)OX² or —OH groups.

10. The method for preparing an electrolytic capacitor of claim 1 wherein said n is at least 2.

11. The method for preparing an electrolytic capacitor of claim 1 wherein said n is no more than 6.

12. The method for preparing an electrolytic capacitor of claim 1 wherein said anode comprises a material selected from the group consisting of niobium, aluminum, tantalum and NbO.

13. The method for preparing an electrolytic capacitor of claim 1 wherein said anode has a charge density of at least 50,000 CV/g.

14. The method for preparing an electrolytic capacitor of claim 1 wherein said dopant further comprises phosphorus containing compound defined by:
R³—(OₓP(O)(OX⁴)₂)ₚ
wherein R³ is —OH, an optionally substituted aliphatic chain of up to 10 carbons, an optionally substituted aliphatic ring of up to 10 carbons or an optionally substituted aromatic ring;
each X⁴ is independently selected from H⁺, Li⁺, Na⁺, NH₄⁺ and organic amino cation;
x is 0 or 1 with the proviso that when x=1, R³ is not —OH; and
p is an integer indicating the number of substituents on R³.

15. The method for preparing an electrolytic capacitor of claim 1 wherein said conductive polymer is represented by Formula A: 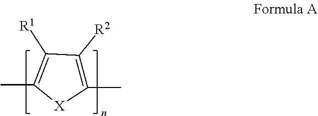
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

16. The method for preparing an electrolytic capacitor of claim 15 wherein said conductive polymer is 3,4,polyethylene dioxythiophene.

17. The method for preparing an electrolytic capacitor of claim 1 wherein conductive polymer layer comprises a small molecule dopant.

18. The method for preparing an electrolytic capacitor of claim 17 wherein said small molecule dopant is p-toluenesulfonate

19. The method for preparing an electrolytic capacitor of claim 1 wherein conductive polymer layer comprises conductive polymer comprising self-doping functionality.

20. The method for preparing an electrolytic capacitor of claim 1 wherein said conductive polymer layer further comprises a cross-linker.

21. The method for preparing an electrolytic capacitor of claim 20 wherein said cross-linker comprises at a reactive group selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides.

22. The method for preparing an electrolytic capacitor of claim 1 further comprising forming an adhesion layer comprising at least one of a carbon containing layer or a metal containing layer after said applying said treatment.

23. The method for preparing an electrolytic capacitor of claim 22 further comprising forming a protective coating on said adhesion layer.

24. A method for preparing an electrolytic capacitor comprising:
forming an anode with a dielectric on said anode;
forming a conductive polymer layer on said dielectric wherein said forming of said conductive polymer layer comprises sequential applying multiple layers of a conductive polymer on said dielectric;
applying a treatment to said conductive polymer layer wherein said treatment comprises a dopant wherein said dopant comprises:
a carboxylic acid compound defined by the formula:
R²—(C(O)OX³)ₘ
wherein:
R² is an aliphatic chain, an aliphatic ring or an aromatic ring and wherein R² is substituted with at least one group selected from the group consisting of —C(O)OX², —OH and an amine; and if R² is an aliphatic chain or an aliphatic ring m is 1 and if R² is an aromatic ring m is at least 1;
X³ is a monovalent cation selected from the group consisting of H⁺, Li⁺, Na⁺, NH₄⁺ and an organic amino cation;
and
a compound selected from the group consisting of:
an aromatic sulfonate compound defined by the formula:
R¹—(S(O)₂OX¹)ₙ
wherein R¹ is an aromatic ring optionally substituted with at least one group selected from the group consisting of —(S(O)₂OX², —C(O)OX², —OH and an amine;
X¹ and X² are independently a monovalent cation selected from the group consisting of H⁺, Li⁺, Na⁺, NH₄⁺ and organic amino cation; and
n is an integer of at least 1;
and phosphorus containing compound defined by:
R³—(OₓP(O)(OX⁴)₂)ₚ
wherein R³ is —OH, an optionally substituted aliphatic chain of up to 10 carbons, an optionally substituted aliphatic ring of up to 10 carbons or an optionally substituted aromatic ring;
each X⁴ is independently selected from H⁺, Li⁺, Na⁺, NH₄⁺ and organic amino cation;
x is 0 or 1 with the proviso that when x=1, R³ is not —OH; and
p is an integer indicating the number of substituents on R³.

25. The method for preparing an electrolytic capacitor of claim 24 wherein said dopant is not added during said sequential applying multiple layers.

26. The method for preparing an electrolytic capacitor of claim 24 wherein said p is at least 2 to no more than 6.

27. The method for preparing an electrolytic capacitor of claim 24 wherein said m is at least 2.

28. The method for preparing an electrolytic capacitor of claim 24 wherein said m is no more than 6.

29. The method for preparing an electrolytic capacitor of claim 24 wherein said R² is substituted with —C(O)OX².

30. The method for preparing an electrolytic capacitor of claim 24 wherein said R² has less than 10 carbons or is a polymeric acid.

31. The method for preparing an electrolytic capacitor of claim 24 wherein Li⁺, Na⁺, NH₄⁺ and organic amino cations accounting for at least 15 molar % of the total cations represented by X¹, X² and X³.

32. The method for preparing an electrolytic capacitor of claim 24 wherein said R¹ is substituted with at least one said —(S(O)₂OX², —C(O)OX² or —OH groups.

33. The method for preparing an electrolytic capacitor of claim 24 wherein said R¹ is substituted with at least two said —(S(O)₂OX², —C(O)OX² or —OH groups.

34. The method for preparing an electrolytic capacitor of claim 24 wherein said n is at least 2.

35. The method for preparing an electrolytic capacitor of claim 24 wherein said n is no more than 6.

36. The method for preparing an electrolytic capacitor of claim 24 wherein said anode comprises a material selected from the group consisting of niobium, aluminum, tantalum and NbO.

37. The method for preparing an electrolytic capacitor of claim 24 wherein said anode has a charge density of at least 50,000 CV/g.

38. The method for preparing an electrolytic capacitor of claim 24 wherein said conductive polymer is represented by Formula A: 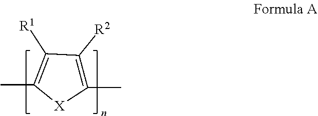
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

39. The method for preparing an electrolytic capacitor of claim 38 wherein said conductive polymer is 3,4,polyethylene dioxythiophene.

40. The method for preparing an electrolytic capacitor of claim 24 wherein conductive polymer layer comprises a small molecule dopant

41. The method for preparing an electrolytic capacitor of claim 40, wherein said small molecule dopant is p-toluenesulfonate

42. The method for preparing an electrolytic capacitor of claim 24 wherein conductive polymer layer comprises conductive polymer comprising self-doping functionality.

43. The method for preparing an electrolytic capacitor of claim 24 wherein said conductive polymer layer further comprises a cross-linker.

44. The method for preparing an electrolytic capacitor of claim 43 wherein said cross-linker comprises at a reactive group selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides.

45. The method for preparing an electrolytic capacitor of claim 24 wherein said phosphorus containing compound is selected from the group consisting of: ammonium, lithium, sodium mono or dihydrogen phosphate, monovalent salt of phytic acid, methyl phosphonic acid, ethyl phosphonic acid, 1,4-phenylene bisphosphonic acid, methyl or dimethyl phosphate, dimetylphosphate, ethyl or diethyl phosphate, phenyl phosphate, diphenyl phosphate or hexafluorophosphate.

46. The method for preparing an electrolytic capacitor of claim 45 wherein said phosphorus containing compound is selected from the group consisting of: monovalent salt of phytic acid, polyvinylphosphonic acid, ethylenediamine tetramethylene phosphonic acid, and oligomers or polymers containing more than one phosphonate group.

47. The method for preparing an electrolytic capacitor of claim 24 further comprising forming an adhesion layer comprising at least one of a carbon containing layer or a metal containing layer after said applying said treatment.

48. The method for preparing an electrolytic capacitor of claim 47 further comprising forming a protective coating on said adhesion layer.

49. A method for preparing an electrolytic capacitor comprising:
forming an anode with a dielectric on said anode;
forming a conductive polymer layer on said dielectric wherein said forming of said conductive polymer layer comprises sequential applying multiple layers of a conductive polymer on said dielectric;
applying a treatment to said conductive polymer layer wherein said treatment comprises a dopant wherein said dopant comprises a phosphorus containing compound defined by:
R³—(OₓP(O)(OX⁴)₂)ₚ
wherein R³ is —OH, an optionally substituted aliphatic chain of up to 10 carbons, an optionally substituted aliphatic ring of up to 10 carbons or an optionally substituted aromatic ring;
each X⁴ is independently selected from H⁺, Li⁺, Na⁺, NH₄⁺ and organic amino cation;
x is 0 or 1 with the proviso that when x=1, R³ is not —OH;
and
p is an integer indicating the number of groups on R³.

50. The method for preparing an electrolytic capacitor of claim 49 wherein said dopant is not added during said sequential applying multiple layers.

51. The method for preparing an electrolytic capacitor of claim 49 wherein said p is at least 2 to no more than 6.

52. The method for preparing an electrolytic capacitor of claim 49 wherein Li⁺, Na⁺, NH₄⁺ and organic amino cations accounting for at least 20 molar % of the total cations represented by X⁴.

53. The method for preparing an electrolytic capacitor of claim 49 wherein said anode comprises a material selected from the group consisting of niobium, aluminum, tantalum and NbO.

54. The method for preparing an electrolytic capacitor of claim 49 wherein said anode has a charge density of at least 50,000 CV/g.

55. The method for preparing an electrolytic capacitor of claim 49 wherein said dopant further comprises an aromatic sulfonate compound defined by the formula:
R¹—(S(O)₂OX¹)ₙ
wherein R¹ is an aromatic ring optionally substituted with at least one group selected from the group consisting of —(S(O)₂OX², —C(O)OX², —OH and an amine;
X¹ and X² are independently a monovalent cation selected from the group consisting of H⁺, Li⁺, Na⁺, NH₄⁺ and organic amino cation; and
n is an integer of at least 1.

56. The method for preparing an electrolytic capacitor of claim 49 wherein said conductive polymer is represented by Formula A: 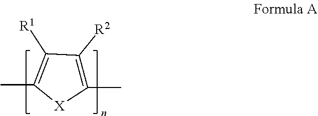
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

57. The method for preparing an electrolytic capacitor of claim 56 wherein said conductive polymer is 3,4,polyethylene dioxythiophene.

58. The method for preparing an electrolytic capacitor of claim 49 wherein conductive polymer layer comprises a small molecule dopant

59. The method for preparing an electrolytic capacitor of claim 58, wherein said small molecule dopant is p-toluenesulfonate

60. The method for preparing an electrolytic capacitor of claim 49 wherein conductive polymer layer comprises conductive polymer comprising self-doping functionality.

61. The method for preparing an electrolytic capacitor of claim 49 wherein said conductive polymer layer further comprises a cross-linker.

62. The method for preparing an electrolytic capacitor of claim 61 wherein said cross-linker comprises at a reactive group selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides.

63. The method for preparing an electrolytic capacitor of claim 49 wherein said phosphorus containing compound is selected from the group consisting of: ammonium, lithium, sodium mono or dihydrogen phosphate, monovalent salt of phytic acid, methyl phosphonic acid, ethyl phosphonic acid, 1,4-phenylene bisphosphonic acid, methyl or dimethyl phosphate, dimetylphosphate, ethyl or diethyl phosphate, phenyl phosphate, diphenyl phosphate or hexafluorophosphate.

64. The method for preparing an electrolytic capacitor of claim 63 wherein said phosphorus containing compound is selected from the group consisting of: monovalent salt of phytic acid, polyvinylphosphonic acid, ethylenediamine tetramethylene phosphonic acid, and oligomers or polymers containing more than one phosphonate group.

65. The method for preparing an electrolytic capacitor of claim 49 further comprising forming an adhesion layer comprising at least one of a carbon containing layer or a metal containing layer after said applying said treatment.

66. The method for preparing an electrolytic capacitor of claim 65 further comprising forming a protective coating on said adhesion layer.
